(19) United States
(12) Patent Application Publication
(10) Pub. No.: US 2026/0117560 A1
(43) Pub. Date: Apr. 30, 2026

(54) LUGGAGE LOCK

(71) Applicant: ABUS AUGUST BREMICKER SÖHNE KG, Wetter-Volmarstein (DE)

(72) Inventor: Bernhard GARTHE, Gevelsberg (DE)

(21) Appl. No.: 19/115,563

(22) PCT Filed: Sep. 18, 2023
(86) PCT No.: PCT/EP2023/075587

§ 371 Date: Mar. 26, 2025

(30) Foreign Application Priority Data
Sep. 27, 2022 (DE) 10 2022 124 869.0

(51) Int. Cl. E05B 37/00; A45C 5/03; A45C 13/18

(52) U.S. Cl. CPC E05B 37/0048; A45C 5/03; A45C 13/18

(57) ABSTRACT

A luggage lock for securing a piece of luggage that can be opened non-destructively by a security institution has a combination locking mechanism at which a numerical code can be manually set to selectively lock a securing section of the piece of luggage relative to the luggage lock or to release the securing section and to allow an opening of the piece of luggage. The securing section can be released by setting a numerical code that corresponds to a release code and can be locked by setting a numerical code that does not correspond to the release code. The release code can be changed by an owner of the piece of luggage. Furthermore, the luggage lock includes an identification device that provides a lock identification code that is individually associated with the luggage lock.

### CROSS-REFERENCE TO RELATED APPLICATIONS

The present application is the National Phase entry of International Patent Application No. PCT/EP2023/075587 filed Sep. 18, 2023, which claims priority to German Patent Application 10 2022 124 869.0 filed Sep. 27, 2022.

### TECHNICAL FIELD

The present disclosure relates to a luggage lock for securing a piece of luggage that may be opened non-destructively by a security institution and that has a combination locking mechanism at which a numerical code may be manually set. A securing section of the piece of luggage may, by the combination locking mechanism, be selectively locked relative to the luggage lock to secure a closed state of the piece of luggage or be released to enable an opening of the piece of luggage. The securing section of the piece of luggage may be released by setting a numerical code at the combination locking mechanism that corresponds to a release code, whereas the securing section of the piece of luggage may be locked by setting a numerical code at the combination locking mechanism that does not correspond to the release code.

### BACKGROUND

Such luggage locks may generally be provided to secure a piece of luggage, in particular to prevent unauthorized access to items taken along in the piece of luggage. However, in addition to preventing theft, luggage locks may also serve to secure the piece of luggage against a subsequent addition of prohibited substances and/or items, for example of contraband items or drugs, that may be added to the piece of luggage by unauthorized third parties at an unattended moment and/or after the check-in at an airport counter, with the intent of transporting the items in the piece of luggage to a destination airport or a stopover and to remove them there again. However, if such an item is detected in a piece of luggage, the owner of said piece of luggage will usually find it difficult to exonerate himself/herself from the suspicion of having already originally carried the items.

While luggage locks may thus serve, on the one hand, to ensure the security of the items carried in a piece of luggage, it is in particular necessary in air travel to prevent prohibited and/or dangerous substances or items, in particular explosives or drugs, from being carried in the checked-in luggage. Therefore, it may be necessary for a piece of luggage that has already been checked in to be opened and checked by a security institution without the presence of the owner of the piece of luggage to be able to detect such items or substances. In the present context, a security institution may in particular be understood as an authority or a security service provider, in particular a state-authorized security service provider.

However, to also enable checks of pieces of luggage that are secured by a luggage lock without the security institutions having to break open the luggage lock for this purpose, it is necessary to provide the security institutions with a possibility of opening such luggage locks without destruction. So far, this has been solved by additionally providing a further locking mechanism for luggage locks having a combination locking mechanism, which further locking mechanism may be opened by a respective special key from a predetermined selection of special keys, wherein these keys were made available to the employees of the security institution. Such luggage locks for which the US Transportation Security Administration (TSA) guarantees a non-destructive opening and which may therefore in particular be marked and designated as TSA locks are, for example, known from U.S. Pat. No. 8,875,552 B2, WO 2021/129042 A1, US 2019/0055753 A1 and US 2017/0073999 A1.

To enable the security institutions to open the luggage locks quickly, it is, however, necessary to clearly mark the respective special key to be used at the luggage lock, wherein only a limited number of currently eight different special keys is furthermore provided and each TSA lock thus has to be opened by a respective one of these eight special keys. However, this limits the security against manipulation of such luggage locks since unauthorized persons may also gain access to a plurality of luggage locks by forging one or more of the special keys used by the security institutions or by stealing such special keys. Furthermore, any theft or manipulation attempts may be carried out quickly and inconspicuously due to the indication on the luggage lock of the special key to be used so that bystanders have to gain the impression that the authorized owner is opening the luggage lock with the intended key.

The security of a piece of luggage locked by such a luggage lock may therefore not be guaranteed to the desired extent and, moreover, owners of pieces of luggage may only with difficulty exonerate themselves from the unjustified suspicion of having already originally carried any prohibited items found in a piece of luggage which were only added subsequently and not by the owner since subsequent access to the piece of luggage must appear improbable in view of its securing by an intact luggage lock. However, this also ultimately involves a great deal of effort on the part of security institutions to prosecute innocent people.

It is therefore an object of the present disclosure to provide a luggage lock that may be opened without destruction by a security institution, that has a combination locking mechanism, and that offers a convenient possibility for a non-destructive opening by an employee of the security institution during a check while simultaneously providing a high level of security against unauthorized opening attempts.

### SUMMARY

This object is satisfied by a luggage lock having the features of the present disclosure.

With this luggage lock, the release code may be changed by an owner of the piece of luggage. The luggage lock further has an identification device that provides a lock identification code that is individually associated with the luggage lock and that may be read in a contactless manner.

The luggage lock may thus be easily and conveniently locked or unlocked by setting a release code or adjusting the release code in order thereby to lock or release a securing section of the piece of luggage relative to the luggage lock. For example, the securing section of the piece of luggage may be a movable handle of a zipper that may be selectively locked relative to the luggage lock to prevent an opening of the zipper. For this purpose, the luggage lock may, for example, be fastened to a luggage body of the piece of luggage and have a lock body into which the handle or the handles of the zipper may be introduced to be able to be locked there. However, as an alternative to fastening the luggage lock to the piece of luggage, the luggage lock may also be releasable from the luggage lock and may, for example, have a rigid U-shaped hoop by which two handles of a zipper may be connected to one another to be able to prevent an opening of the zipper by locking the U hoop to a lock body of the luggage lock.

Further, the securing section of the piece of luggage may, for example, be an engagement strip of a buckle closure that may be arranged at one container part of a luggage body and that may be engaged behind by a buckle arranged at another container part of the luggage body to connect the container parts to one another and to close the luggage body. To lock the engagement strip relative to the luggage lock, a movement of a catch, which is provided at the buckle and by which the engagement of the buckle at the engagement strip may be released, may in particular be blocked so that the engagement strip may no longer be moved relative to the buckle. In such embodiments, the luggage lock may in particular be integrated into the buckle of the piece of luggage.

Furthermore, the securing section may, for example, be formed by a stationary hoop at a lock environment of the piece of luggage and, for example, a bolt that may be arranged at a container part of a luggage body of the piece of luggage and, by closing the piece of luggage, may be introduced into an introduction opening at the other container part to be able to be locked there by the luggage lock. Again, the luggage lock may in particular be arranged at the other container part and/or integrated into the other container part for this purpose.

In general, the luggage lock or a part of the luggage lock, on the one hand, and the securing section of the piece of luggage, on the other hand, are movable relative to one another when the securing section is released.

The luggage lock thus makes it possible to conveniently secure or release a closed state of the piece of luggage by merely having to manually set or adjust a release code without, for example, a key being required for actuating the lock. Unlike with conventional TSA locks, provision is, however, not made to provide an additional locking mechanism to be actuated by a special key, in particular an additional mechanical locking mechanism, via which employees of the security institution may open the luggage lock. Rather, the luggage lock in the form of the combination locking mechanism may solely have a single locking mechanism by which the securing section of the piece of luggage may be selectively locked or released relative to the luggage lock.

To nevertheless enable the security institutions to open the luggage lock non-destructively, the luggage lock has an identification device that provides a lock identification code by which the luggage lock may be uniquely identified. This enables an owner of the luggage lock to store a data pair, which comprises the lock identification code and the release code, in a database readable by the security institution before the start of a journey so that an employee of the security institution may, after reading the identification device, read the release code associated with the lock identification code from the database and may open the luggage lock by setting the release code at the combination locking mechanism. In this regard, employees of the security institution may be offered a possibility of opening the luggage lock non-destructively by actuating the same combination locking mechanism that is also available to the owner without a separate locking mechanism having to be provided for the security institutions that may generally represent a point of attack for manipulations.

Since the lock identification code may be read in a contactless manner, a machine reading of the lock identification code may in particular also be made possible in that, for example, an optical code, for example a QR (quick response) code, may be scanned by a transmission device, and in particular the camera of a smartphone of an employee of the security institution, and the release code may be retrieved from the database via a corresponding app. The release code may then be transmitted to the transmission device and displayed there so that the employee may open the luggage lock. Alternatively thereto, it is, however, for example, also possible for the lock identification code, for example in the form of a numerical sequence and/or a letter sequence, to be visibly displayed at an outer side of the luggage lock so that an employee of the security institution may, for example, read off the lock identification code and enter it at a transmission device, in particular a smartphone, in order to then request the release code.

While the security institutions may thus be offered a convenient possibility of non-destructively opening the luggage lock, the owner of the luggage lock may, since the release code is changeable, however for example ensure that the security institutions are only permitted access to the piece of luggage for the period of a journey. For example, the owner may change the release code after receiving the piece of luggage so that the piece of luggage, after it is received by the owner, may not be opened by persons who have gained unauthorized access to the database either. Such unauthorized access to the database is ultimately comparable to replicating a TSA key in previous solutions, wherein, in contrast to previous solutions, the owner may, by changing the release code, protect against unauthorized access to the possibility of opening the luggage lock non-destructively that is made available to the security institutions.

Before starting a further journey, the owner may, for example, transmit a changed release code to the database again and associate it with the lock identification code or re-set the original release code to enable the employees of the security institutions to access the piece of luggage again for the duration of that journey. It is generally, however, also possible for an owner of the luggage lock to leave a release code unchanged and to accept that the luggage lock may be permanently opened by employees of the security institution who may read the database.

The basic operation of a combination locking mechanism is known to the skilled person, for example, from U.S. Pat. No. 8,596,103 B2, EP 1 256 673 A1 and DE 10 2020 114 042 A1 whose contents are incorporated into the present disclosure with respect to this operation of a combination locking mechanism. The operation of combination locking mechanisms is also apparent from the already mentioned documents on TSA locks U.S. Pat. No. 8,875,552 B2, WO 2021/129942 A1, US 2019/0055753 A1 and US 2017/0073999 A1 so that reference is also made thereto and the operation of a combination locking mechanism is not explained in detail.

A lock identification code that is individually associated with a luggage lock can—with respect to the present disclosure—in particular be genuinely associated with said luggage lock and/or can, for example, be generated and deposited in or attached to the identification device by a manufacturer of the luggage lock. Further, the lock identification code can be in particular immutable in some embodiments. The lock identification code can, thus, be permanently and unalteredly associated with the luggage lock, while the opening code and/or the release code may—where applicable—be changeable, as will be explained in more detail below. Further, the lock identification code may in particular be associated with the luggage lock already at the point in time at which the luggage lock is delivered by the luggage manufacturer, such that the lock identification code may in particular not be subsequently (after the delivery) or selectively generable, in particular neither by the owner of the luggage lock nor by a security institution meant to be able to open the luggage lock without destruction.

In case reference is made to a lock identification code in the present disclosure, the lock identification code is in general to be understood as being individually associated with a luggage lock to facilitate an identification of said luggage lock.

Further embodiments are explained in the claims, in the description, and in the drawings.

In some embodiments, the lock identification code may be machine-readable by a mobile transmission device, in particular a smartphone.

For example, provision may be made to provide the lock identification code in optically readable form at an outer side of the luggage lock so that the lock identification code may be scanned by a camera of a smartphone or another transmission device without requiring a manual entry of the lock identification code. An employee of a security institution therefore only has to bring a transmission device and in particular a smartphone into the vicinity of the luggage lock to be able to contactlessly machine-read the lock identification code and transmit it to a database of the security institution, whereupon the associated release code may be transmitted to the transmission device and displayed there. The employee may then set the release code at the combination locking mechanism and open the luggage lock directly via the same combination locking mechanism that is also available to the owner and by the release code stored by the owner in the database. In the same way, the owner may also conveniently machine-read the lock identification code, for example by a transmission device and/or smartphone, in order to then transmit the lock identification code together with the release code to the database. As an alternative to an optical reading, in some embodiments, a contactlessly machine-readable lock identification code may also be readable via a radio connection, as explained in more detail below.

However, as an alternative or in addition to a machine-readable lock identification code, in some embodiments, the luggage lock may also have a visually readable lock identification code that may, for example, comprise a numerical sequence. In such embodiments, provision may in particular be made that an employee of a security institution enters the read-off lock identification code at the transmission device, for example via a touch screen, and then transmits it to the database to be able to request the associated release code. The owner of the luggage lock may also possibly read off the lock identification code in this manner and enter it at a transmission device.

In some embodiments, the lock identification code may comprise an optically readable one-dimensional or two-dimensional optical code.

For example, a barcode or QR (quick response) code may be attached to an outer side of the luggage lock and may in particular be scanned by a camera of a smartphone and thereby be contactlessly machine-read. An employee of a security institution therefore only has to control a mobile transmission device, in particular a smartphone, for example via an app, to read the lock identification code visible at the outside to be able to immediately request the release code from a database of the security institution.

The lock identification code may be formed by laser engraving at the luggage lock in some embodiments. The application of the lock identification code by laser engraving may in particular provide improved protection of the lock identification code against damage and/or changes compared to, for example, an adhesive bonding or printing on, which may be provided alternatively. For example, such a lock identification code may be formed at an outer side of a housing of the luggage lock.

The optically readable code may be covered by a protective window in some embodiments. Such a protective window may in particular protect the lock identification code against damage and/or changes. It may thereby be achieved that the lock identification code of the luggage lock may be reliably read over long periods of time to be able to fulfill the functions of the luggage lock for securing the piece of luggage, on the one hand, and for enabling a non-destructive opening by reading the lock identification code and requesting the associated release code, on the other hand, over long periods of time. Such a protective window may in particular cover a one-dimensional or two-dimensional optical code formed by laser engraving at an outer side of the luggage lock and/or a printed-on or adhesively bonded one-dimensional or two-dimensional optical code.

In some embodiments, the lock identification code may be readable via a radio connection. In such embodiments, the lock identification code may in particular be provided as a wirelessly detectable electronic code that may be read by establishing a radio connection between a mobile transmission device, in particular a smartphone, and the luggage lock. For example, in some embodiments, the lock identification code may be readable via an RFID (radio frequency identification) connection, in particular an NFC (near field communication) connection, or a Bluetooth connection. The lock identification code may in particular be readable via a relatively short-range radio connection, for instance an NFC or Bluetooth connection, such that it is only possible to read the lock identification code via a transmission device that is located in the immediate vicinity of the luggage lock. It may hereby be ensured that persons standing at a distance from the luggage lock or the piece of luggage cannot read the lock identification code and cannot possibly read the release code from the database to be able to open the piece of luggage without authorization at a later time.

In some embodiments, the identification device may comprise an active or passive transponder for storing and transmitting the lock identification code.

For example, the luggage lock may have an NFC tag as a passive transponder in which the lock identification code is provided. A passive transponder may in particular be activated by electrical energy wirelessly provided via the transmission device, in particular a smartphone, and may be controlled to transmit the lock identification code without having to integrate a separate electrical energy source for the supply of the transponder into the luggage lock for this purpose. Such a passive transponder may in particular be configured to transmit the lock identification code over short ranges and, for example, an NFC (near field communication) connection.

In contrast thereto, an active transponder, for example another RFID tag, may have its own energy source to also be able to transmit the lock identification code over larger ranges compared to a passive transponder. Even with such an active transponder, provision may, however, be made to activate the energy source only in the event of an electrical signal received via a radio connection in order to avoid an unnecessary energy consumption at times when the lock identification code is not requested. Therefore, an active transponder may also be realized by providing only a relatively small electrical energy source.

A passive transponder, for example an NFC tag, and an active transponder, for example an RFID tag, may in particular have a memory in which the lock identification code may be stored. This may in particular take place by the manufacturer of the lock. Furthermore, it is generally possible to also provide such transponders with writable memories, for example, to enable documentation of opening attempts in the luggage lock, as will be explained below.

In some embodiments, the transponder may be embedded in a housing of the luggage lock. The transponder may in particular be embedded in a plastic housing of the luggage lock that may, for example, form an outer housing or an outer shell of the luggage lock and that may surround an inner metal housing of the luggage lock. Protection of the transponder from external influences may hereby in particular be achieved with a simultaneous reliable radio connection.

In some embodiments, the luggage lock may have a memory in which the lock identification code is stored. This memory may in particular be the aforementioned memory of a transponder so that no separate energy source and/or interface for the memory is required. Alternatively thereto, a separate memory, such as a non-volatile semiconductor memory and/or an EEPROM, may, however, also be provided that is connected to a radio module and a control device to enable a reading of the lock identification code.

In some embodiments, the memory may be configured to store information about a query, in particular a query that took place last, of the lock identification code. In particular, the memory may further be configured to document information transmitted by the mobile transmission device about a point in time at which the lock identification code is queried and/or information about the mobile transmission device, for example a device identification, in the memory. In this regard, for example in an app for reading the lock identification code, provision may be made that information about the point in time of the query and/or a device identification is always also transmitted in the course of a request for the lock identification code. Depending on the memory capacity of the memory, in particular a respective last query of the lock identification code or a plurality of last queries may be documented.

Since such information and in particular the querying of the lock identification code may be stored in a memory of the luggage lock, a user may, after receiving the piece of luggage, track whether the lock identification code was read during the journey and the requirement of being able to read the associated release code from the database was thus accomplished. In this regard, the owner of the luggage lock may be provided with information or at least an indication of whether the luggage lock or the piece of luggage was opened by an employee of the security institutions during the journey. Furthermore, such a documentation enables the owner to prove, for example, that the lock identification code was read after the piece of luggage was handed in at a check-in counter and that the piece of luggage was thus at least probably opened in order to exonerate himself/herself from the suspicion of having already originally carried any prohibited items and/or substances. The documentation of further information, such as a point in time of the reading, a device identification of the reading transmission device and/or also information about a location at which the lock identification code was read, may in such cases furthermore serve to clarify which persons were involved in the addition of the items or substances.

Furthermore, a documentation of possible opening processes, for example as a documentation of requests for the release code from the database, may generally also take place in the database of the security institution, in particular to enable the security institution to trace checks that have been carried out. Due to an in particular additional documentation of queries of the lock identification code in a memory of the luggage lock, it may, however, be ensured that opening processes may also be traced in the case of a possible manipulation of the database so that the owner of the luggage lock may in particular be provided with proof of subsequent opening processes independently of corresponding documentation by the security institution.

In some embodiments, the luggage lock may be of a purely mechanical design, in particular with respect to the possibility of locking and releasing the securing section. A purely mechanical luggage lock may in particular not have an energy source for the supply of components of a locking mechanism; instead, the locking or releasing of the securing section may take place purely mechanically. Therefore, the luggage lock may in particular not have an electromechanical locking mechanism.

Furthermore, with regard to the locking and releasing of the securing section, the luggage lock may solely have the combination locking mechanism so that in particular the locked securing section may be releasable solely by setting the release code. Furthermore, the luggage lock may not have a locking mechanism to be actuated by a key. Rather, only the combination locking mechanism may be provided for selectively locking or releasing the securing section of the piece of luggage and may be actuated by both the owner and employees of the security institution to selectively open or lock the luggage lock. Thus, in particular no separate locking mechanism may be provided for the security institutions.

However, in some embodiments, in addition to the combination locking mechanism, the luggage lock may have a further mechanical locking mechanism to be actuated by a TSA key. Such luggage locks may, for example, be opened non-destructively by security institutions that do not participate in the TSA system by reading the release code from a database after identifying the luggage lock, whereas security institutions that wish to use the existing TSA system may open the luggage lock by an associated TSA key.

Furthermore, the luggage lock may generally be designed without any electrical energy source (passive embodiment) or may only have a radio-chargeable electrical energy source, for example a radio-chargeable electrical energy source of a passive transponder (quasi-passive embodiment). In such a quasi-passive embodiment, the transponder that may be excited by electromagnetic radiation may in particular have a small energy source, for example a capacitor, that may be charged by the received radiation in order, for instance, to enable a transmission of the lock identification code over short ranges. Furthermore, it is generally possible for the luggage lock to have an active transponder, for example an RFID tag, having a small separate energy source to be able to transmit the lock identification code, wherein even in such embodiments the use of electrical energy may be limited to providing the lock identification code and/or documenting requests for the lock identification code, whereas the locking and release of the securing section may take place purely mechanically. However, a memory of a passive transponder may generally also be writable.

The luggage lock may further have a lock body into which the securing section of the piece of luggage may be introduced to be locked. Furthermore, in some embodiments, the luggage lock may have a hoop lockable to a lock body in order, by the hoop, to be able to lock a securing section of the piece of luggage, for example movable handles of a zipper, relative to the luggage lock or to release said securing section from the luggage lock.

The combination locking mechanism may have a latch to be able to lock or release the securing section directly or indirectly, for example by blocking a catch. Such a latch may, for example, be preloaded in the direction of a locking position to be able to automatically hold the securing section after the introduction into a lock environment and/or a lock body of the luggage lock without the latch first having to be manually moved into the locking position.

Furthermore, in some embodiments, the combination locking mechanism may comprise a plurality of rotatable code rings for setting a numerical code, for example, three code rings or four code rings. In this respect, the code rings may be arranged coaxially to one another or have axes of rotation offset in parallel.

Furthermore, the release code may in particular comprise a numerical sequence. Possibilities for designing such combination locking mechanisms, in particular with rotatable code rings that are arranged coaxially or with parallel axes of rotation, are generally known to the skilled person so that it is not necessary to go into detail here.

The present disclosure furthermore relates to a piece of luggage that comprises a luggage body, having a securing section, a first container part and a second container part movable relative to the first container part between an open position and a closed position, and a luggage lock of the kind explained above. The second container part enables access to an inner space of the luggage body in the open position and blocks access in the closed position. The second container part may further be secured in the closed position by locking the securing section.

The securing section may in particular be arranged at the first container part or at the second container part, wherein the luggage lock may in particular be arranged at the respective other container part. By locking the securing section relative to the luggage lock, the second container part may therefore also be locked relative to the first container part and may thereby be secured in the closed position. Furthermore, provision may, however, be made that the two container parts may be secured to one another by a luggage lock that may be released from the piece of luggage. For example, the two container parts may be connected to one another by a zipper, wherein in particular movable handles of such a zipper may be connectable to one another by a hoop of a luggage lock that is releasable from the piece of luggage and may be securable to one another by locking the hoop to a lock body in order to block an opening of the zipper and thereby to secure the second container part to the first container part.

Since the luggage lock of such a piece of luggage may be identified by reading the lock identification code from the identification device, an employee may, after such a reading of the lock identification code, request a release code that is associated with the luggage lock and that is stored in a database to be able to non-destructively open the luggage lock in the course of a check by setting the release code and to be able to move the second container part into the open position. After such a check, the second container part may again be moved into the closed position and secured by adjusting the release code so that the original securing of the piece of luggage may be easily restored after the check.

Furthermore, the configuration of the piece of luggage with such a luggage lock makes it possible to ultimately also identify the piece of luggage individually by reading the lock identification code. This may, for example, also be used independently of a possible transmission of the release code to a database of a security institution, for example during baggage tracking, in that, for example, a lock identification code that may be read via a radio connection, for instance an RFID connection, may be registered at various points of the baggage handling and the piece of luggage may thus be tracked. Furthermore, a reading of the lock identification code may, for example, take place when leaving an airport or a baggage claim hall to be able to trace whether the piece of luggage has left such a location and thereby to be able to investigate, for example, a theft or an accidental taking along of the piece of luggage. Furthermore, an owner of a stolen piece of luggage may, for example, report the piece of luggage missing to a security institution, wherein the piece of luggage may, for example, be found as a result of a reading of the lock identification code during a subsequent check-in of the piece of luggage by an unauthorized person.

In this regard, the present disclosure also relates, independently of the provision of a luggage lock that may be opened non-destructively by a security institution, to a piece of luggage having a luggage lock that has a locking mechanism, by which a securing section of the piece of luggage may be selectively locked or released relative to the luggage lock, and that has an identification device that provides a contactlessly machine-readable lock identification code. In this respect, the lock identification code may in particular be readable via a radio connection, as already explained above, wherein an optical reading may also be provided. Furthermore, such a luggage lock may in particular have a combination locking mechanism, wherein other locking mechanisms may, however, generally also be provided, for example a locking mechanism configured with a lock cylinder to be actuated by a mechanical key or an electromechanical locking mechanism, since the aforementioned possibilities for baggage tracking may generally be implemented independently of the locking mechanism used.

In some embodiments, the piece of luggage may have a luggage closure that is configured to keep the second container part in the closed position, wherein the combination locking mechanism may be arranged at the luggage body and the securing section may be arranged at the luggage closure, or vice versa.

For example, the luggage closure may be a buckle or a zipper, wherein the two container parts may, for instance, already be held at one another by closing such a buckle or by closing a zipper. However, the buckle or the zipper may generally remain released for a manual opening by the mere closing so that the second container part may only be secured in the closed position by locking the securing section.

In embodiments of the piece of luggage with a buckle, provision may, for example, be made that the buckle engages behind an engagement strip arranged at the luggage body to hold the two container parts at one another. The combination locking mechanism may in particular be integrated into the buckle to be able to selectively lock a catch by which the engagement to the engagement strip may be released when the catch is not locked. In the case of a zipper, on the other hand, the securing section may, for example, be formed by one or two handles of the zipper, wherein the handles may, for example, be introduced into the lock body of a luggage lock fastened to the luggage body and may be locked there. Alternatively thereto, the luggage lock may, however, for example, also be configured as a releasable padlock, in particular having a U hoop, in order, for instance, to be able to connect two handles of a zipper to one another by the hoop and to secure them to one another by locking the hoop to a lock body of the luggage lock.

Furthermore, in the case of a luggage lock integrated into or fastened to the piece of luggage, provision may also be made that the lock identification code is attached to the luggage body, for example as a QR code, so that the luggage lock may ultimately be identifiable via the piece of luggage. Irrespective of the attachment of the lock identification code to the luggage lock or to the luggage body, an identification of the luggage lock and the piece of luggage may take place via the lock identification code to be able to associate the piece of luggage with a specific owner.

The present disclosure further relates to a method of providing a release code for a security institution for opening a luggage lock that has a combination locking mechanism at which a numerical code may be manually set, in particular a luggage lock of the kind described herein and/or a luggage lock of a piece of luggage of the kind described herein. The method comprises the steps:
transmitting a lock identification code that is individually associated with the luggage lock to a database; and
transmitting a release code that is associated with the combination locking mechanism to the database.

These steps and the further method steps described in the following may in particular be performed by an owner of the luggage lock. Since the owner may transmit a data pair of a lock identification code and an associated release code to a database, the release code may generally be read from the database after an identification of the luggage lock by an employee of a security institution so that the employee may open the luggage lock non-destructively by setting the release code. On the other hand, no separate locking mechanism is required to enable the security institutions to open the luggage lock without destruction. The transmission of the data pair and in particular the release code may be performed by an owner in particular before the start of a journey, wherein the release code may, for example, be changed again by the owner of the luggage lock after a subsequent receiving of the piece of luggage in order to ensure that the security institutions or other persons who may possibly gain unauthorized access to the database are only permitted to open the luggage for the period of the journey.

In some embodiments, the lock identification code and the release code may be transmitted to a database readable by the security institution, in particular readable by a security institution with the duty of performing baggage checks at airports. In this regard, by transmitting the data pair of the lock identification code and the release code, the security institutions may selectively be provided with a possibility of opening the luggage lock non-destructively in case of a necessary check and of gaining access to the piece of luggage.

In some embodiments, the lock identification code and the release code may be transmitted to the database by a mobile transmission device, in particular a smartphone, via a wireless connection.

For example, provision may be made that an owner scans an optically readable lock identification code by a smartphone or its camera or reads a lock identification code readable via a radio connection, for example, from an NFC tag or another RFID tag of the luggage lock. This may, for example, take place by calling up an app installed on the transmission device or smartphone and selecting the corresponding function. Thereupon, the owner may manually enter the selected release code of the combination locking mechanism, in particular likewise the in mentioned app, and for example as a numerical sequence, and may transmit the data pair of the lock identification code and the release code to the database by a corresponding command via a wireless connection. A WLAN/WiFi connection or a mobile radio connection may in particular be provided for this purpose. Alternatively thereto, provision may also be made that the owner manually enters the lock identification code as a numerical sequence and/or letter sequence at the transmission device.

In some embodiments, the lock identification code may be contactlessly machine-read from an identification device of the luggage lock and/or from a memory of the transmission device by the transmission device before the transmission to the database.

An owner of the luggage lock may in particular read the lock identification code from the identification device of the luggage lock, for example by the transmission device as an optically readable optical code or as a wirelessly detectable electronic code, without requiring a manual entry of the lock identification code at the transmission device. Furthermore, provision may be made that the lock identification code is stored in a memory of the transmission device, for example when starting to run an app for transmitting the data pair of the lock identification code and the release code, so that the owner of the luggage lock only has to enter a release code and set a command for transmitting the data pair in order to provide the lock identification code and the associated release code to the security institutions.

In some embodiments, the lock identification code may be selected at the transmission device. For example, various luggage locks and/or pieces of luggage of an owner may be stored in an app so that an owner may, for instance, select the respective luggage lock or piece of luggage from a drop-down menu, whereby the associated lock identification code may be loaded from a memory of the transmission device. The owner may then, for example, enter the selected release code at the transmission device and transmit the corresponding data pair to the database.

In some embodiments, the release code may be entered at an input device of the transmission device and may then be transmitted. For example, the transmission device or smartphone may have a touch screen via which a numerical sequence that corresponds to the release code may be entered and, by selecting a corresponding command, may be transmitted to the database together with the lock identification code.

The lock identification code and the release code may be transmitted to the database via an internet website in some embodiments. In particular, a solution for transmitting the lock identification code and the release code may thereby be provided without a mobile transmission device and/or a smartphone being required. For example, a serial number of the luggage lock as the lock identification code, or another identifier associated with the luggage lock, and the release code selected by the owner may be entered at such an internet website and may be transmitted to the database of the security institutions by selecting a corresponding button.

In some embodiments, information about a release period for which the release code is accessible in the database may be transmitted to the database.

Due to such a transmission of a release period, an owner of the luggage lock may in particular determine the time period for which the release code is to be retrievable from the database and accessible to employees of the security institution, wherein the release code may in particular be deleted from the database after the release period has elapsed. In particular due to such a deletion, it may be ensured that unauthorized third parties also cannot read the release code and open the luggage lock through a manipulation of the database after the release period has elapsed. Alternatively thereto, the release code may remain stored in the database, but the output of the release code from the database to a requesting device may be denied after the release period has elapsed. Alternatively or additionally, the owner may further change the release code after receiving the piece of luggage in order to protect the luggage lock against possible manipulations of the database.

However, even with an unchanged release code, it may generally be ensured by such a defining of the release period that, for example, the security institutions are only allowed to access the piece of luggage for the period of a journey. Therefore, the owner does not necessarily have to change the release code after receiving the piece of luggage and have to remember to transmit the changed release code to the database or to set the original release code again before starting a further journey in order to make a non-destructive opening possible for the security institution. Instead, only a release period associated with a respective journey must be transmitted to the database. This may, for example, also take place by communicating a flight number in that the security institution may block an output of the release code from the database after the piece of luggage has been processed at the destination airport.

In some embodiments, an authorization for a retrieval of the release code from the database may be granted to and/or withdrawn from the database. For example, provision may be made that the release code is generally stored after a first transmission to the database, wherein, however, the owner of the luggage lock may, for example via an app of a mobile transmission device, selectively grant a retrieval authorization or, for instance after a journey has been completed, withdraw it. The owner may also hereby ensure that the luggage lock may be opened by employees of the security institution only during the travel period.

In general, however, a retrieval of the release code may also be selectively released or blocked by the security institution if, for instance, the owner transmits a flight number or other information about a travel route to the database after the check-in so that the retrieval of the release code may be blocked after the piece of luggage has been processed at the destination airport. Furthermore, it is also possible for such information about a travel route to be transmitted by employees of an airline to the database if the lock identification code is, for instance, read during the check-in and transmitted with corresponding information about the travel route to the database.

In some embodiments, information about a travel route, in particular an origin airport, a destination airport, a stopover, an airline and/or a flight number, may be transmitted to the database. For example, an owner of the luggage lock may provide such information before the start of a journey to inform the security institutions of the locations at which the piece of luggage is to be expected. This may, for example, enable the security institutions to allow only those employees who are stationed along the travel route to retrieve the release code in order to limit access to the release code as much as possible. Furthermore, the already explained release and blocking of a retrieval of the release code may take place based on such information. Furthermore, provision may be made that information regarding the travel route is transmitted to the database, for example, by an airline whose employees register the piece of luggage and/or the luggage lock at a check-in, for example.

The present disclosure further relates to a method of opening a luggage lock, which has a combination locking mechanism and a contactlessly readable identification device, by a security institution, in particular a luggage lock of the kind described herein and/or a luggage lock of a piece of luggage of the kind described herein, wherein the opening may in particular take place by a release code that has been provided in accordance with a method of the kind explained above. The method comprises the steps:
reading a lock identification code of the luggage lock from the identification device,
transmitting the lock identification code by a mobile transmission device of the security institution to the database and requesting an associated release code for unlocking the combination locking mechanism,
receiving the release code from the database at the mobile transmission device, and
opening the luggage lock by setting the received release code at the combination locking mechanism.

Said method steps may in particular be carried out by an employee of the security institution if the piece of luggage is to be checked.

The reading of the lock identification code of the luggage lock may furthermore in particular take place by the mobile transmission device of the security institution, for example a smartphone, in that, for example, an optically readable optical code or an electronic code readable via a radio connection may be contactlessly machine-read from the identification device of the luggage lock by the transmission device. After the reading of the lock identification code, the employee of the security institution may transmit the lock identification code to the database by the transmission device and may request the associated release code, whereupon the release code may be transmitted to the transmission device. The release code may be received and displayed at the transmission device so that the employee of the security institution may set the release code at the combination locking mechanism of the luggage lock. In this regard, the employee of the security institution may open the luggage lock non-destructively in a quick and easy manner without a separate locking mechanism for the security institutions, which bypasses the combination locking mechanism, having to be provided for this purpose. Said steps for a contactless machine reading of the lock identification code, a transmission of the lock identification code and a requesting of the release code as well as the receiving and displaying of the release code may in particular be performed in an app installed on the transmission device or smartphone. Furthermore, as an alternative to a machine reading of the lock identification code, provision may be made that a visible lock identification code is entered manually at the transmission device and is thereupon transmitted to the database, wherein this may also take place in a corresponding app.

The transmission device of the security institution may in particular be a smartphone on which a corresponding app for communication with the database is installed. However, the calling up of the app and/or the calling up of respective functions of the app may in particular be dependent on a legitimation check and/or identity check in that, for example, a password has to be entered to start the app or an identity check may take place by matching a fingerprint or by a facial recognition. Furthermore, provision may be made that the security institution provides specific transmission devices for the communication with the database. In some embodiments, the database may be readable by the security institution, in particular readable by a security institution with the duty of performing baggage checks at airports. In this regard, said method may enable employees of the security institution at airports to perform baggage checks of pieces of luggage without having to break open a luggage lock securing the piece of luggage for this purpose.

In some embodiments, the lock identification code of the luggage lock may be contactlessly machine-read by the mobile transmission device. As already explained, the lock identification code may for this purpose in particular comprise an optically readable one-dimensional or two-dimensional optical code and/or a wirelessly detectable electronic code that may be readable via a radio connection.

The request for the release code may be documented in the database in some embodiments. Due to such documentation, it may in particular be tracked whether, at what point in time and/or by whom the release code was requested and the luggage lock and/or piece of luggage was/were thus presumably opened. Such a documentation may in particular enable an internal or external controlling of the security institution to track whether and to what extent checks of pieces of luggage have been performed. Furthermore, the documenting of requests for the release code, however, also generally makes it possible to track whether a specific piece of luggage has been opened again after it was handed in at a check-in counter. As a result, an owner of the piece of luggage may, for example, exonerate himself/herself from the unjustified suspicion of having already originally carried a possible prohibited item if it can be proven that the piece of luggage has been opened in the meantime and the request for the release code may in particular not be associated with a check that has actually taken place. In such a case, the security institutions are also offered relief in that they do not have to use capacities for prosecuting the ultimately innocent owner.

In some embodiments, a point in time of the request for the release code, a location of the request for the release code, a device identification of the mobile transmission device of the security institution and/or a person identification of a requesting user may be documented in the database. In particular, it may thus be documented which employee of the security institution requests the release code and accordingly is in any case likely to perform a check of the piece of luggage. Furthermore, this documentation may again, for example, serve to clear up a possible smuggling if, for instance, the device information of a stolen mobile transmission device or an unknown transmission device is detected.

In some embodiments, a request authorization may be assigned to a plurality of mobile transmission devices and/or persons and the release code may only be transmitted when the release code is requested by an authorized person and/or an authorized transmission device. For example, in addition to the request for the release code, a user identification and/or device identification may be transmitted so that it may be tracked from which transmission device the request is made in order to check the request authorization. Such a request authorization may, for example, be assigned to employees of the security institution who are stationed at a previously stored travel route of the piece of luggage. Furthermore, provision may generally be made that an employee who wishes to perform a check of a piece of luggage first has to request a request authorization and/or has to prove the request authorization by a legitimation check and/or identity check in order to ensure that, for example, stolen transmission devices of the security institution may not be easily used to open luggage locks. Furthermore, the request authorization may, however, generally also be assigned to all the employees of a security institution.

In some embodiments, the request authorization may be checked by a legitimation check and/or an identity check, for instance querying a password, fingerprint matching and/or a facial recognition, at the transmission device. Such a check may, for example, take place for each request for the release code, wherein it is also possible to perform the check only when starting an app of the transmission device, in particular at the beginning of a shift, and thereby to prove that the transmission device is still in the possession of an employee of the security institution so that the request authorization does not have to be proven each time a piece of luggage is checked.

In some embodiments, the request authorization may be assigned in dependence on information about a travel route, said information being stored in the database and associated with the lock identification code of the luggage lock. Employees of a security institution who are stationed along a travel route stored in the database and associated with the lock identification code and/or the transmission devices of said employees may in particular be assigned a request authorization. This may make it possible to limit the number of persons and/or transmission devices that are generally authorized to request the release code to be able to prevent the risk of manipulations, for example, by stealing an arbitrary transmission device of the security institution. Alternatively thereto, all the employees of a security institution and/or all the transmission devices of the security institution may, however, also be assigned a request authorization.

In some embodiments, the assignment of the request authorization may be able to be requested by the transmission device. For example, an employee who wants to perform a check and open the luggage lock but does not have a request authorization may request the request authorization to nevertheless be able to perform the check without having to break open the luggage lock. As already explained, provision may also generally be made that the release code is only transmitted after a request authorization has been requested and/or proof of such a request authorization has been transmitted.

In some embodiments, after the lock identification code has been read, information about a point in time of a previous request for the release code may be displayed at the transmission device. In this respect, information about a location of the last request for the release code may in particular also be displayed. An employee of the security institution may thereby, for example, be informed that the luggage lock has already been opened at the same location, for example at the same airport, and that the piece of luggage has been checked accordingly in order, if necessary, to be able to avoid unnecessary multiple checks of a piece of luggage at the same airport.

In some embodiments, the release code may be deleted from the database after a release period stored in the database has elapsed. As already explained, it may hereby in particular be achieved that an owner of the luggage lock may define a time period during which the release code is stored in the database and may therefore generally be retrieved. Outside this release period, on the other hand, no release code associated with the lock identification code is stored in the database in such embodiments due to the deletion of the release code after the release period has elapsed so that it may be ruled out that persons who gain access to the database in an unauthorized manner may open the luggage lock.

In some embodiments, before the release period elapses, information about the elapse of the release period may be transmitted to a transmission device by which the lock identification code and the release code were received at the database. Thus, an owner of the luggage lock may in particular be notified that the stored release period will elapse so that the owner may, for example, subsequently extend the release period if a journey is delayed to allow the security institutions to open the luggage lock non-destructively over an extended release period.

### BRIEF DESCRIPTION OF THE DRAWINGS

The present disclosure will be explained in the following purely by way of example with reference to embodiments and to the drawings. There are shown:

FIG. 1A is a respective representation of a piece of luggage having a luggage lock that may be opened non-destructively by a security institution in an open state;

FIG. 1B is a respective representation of the piece of luggage having the luggage lock that may be opened non-destructively by the security institution in a closed state;

FIG. 2A is a respective representation of a further piece of luggage having a luggage lock that may be opened non-destructively by a security institution in an open state;

FIG. 2B is a respective representation of the further piece of luggage having the luggage lock that may be opened non-destructively by the security institution in a closed state;

FIG. 3A is a respective representation of a luggage lock releasable from a piece of luggage for securing a zipper of the piece of luggage in a locked state and in a released state of the zipper;

FIG. 3B is a respective representation of the luggage lock releasable from the piece of luggage for securing the zipper of the piece of luggage in a released state of the zipper;

FIG. 4A is a respective schematic representation for illustrating a method of providing a release code for a security institution for opening a luggage lock;

FIG. 4B is another respective schematic representation for illustrating the method of providing the release code for the security institution for opening the luggage lock;

FIG. 4C is another respective schematic representation for illustrating the method of providing the release code for the security institution for opening the luggage lock;

FIG. 5A is a respective schematic representation for illustrating a method of opening a luggage lock by a security institution;

FIG. 5B is another respective schematic representation for illustrating the method of opening the luggage lock by the security institution; and

FIG. 5C is another respective schematic representation for illustrating the method of opening the luggage lock by the security institution.

### DETAILED DESCRIPTION

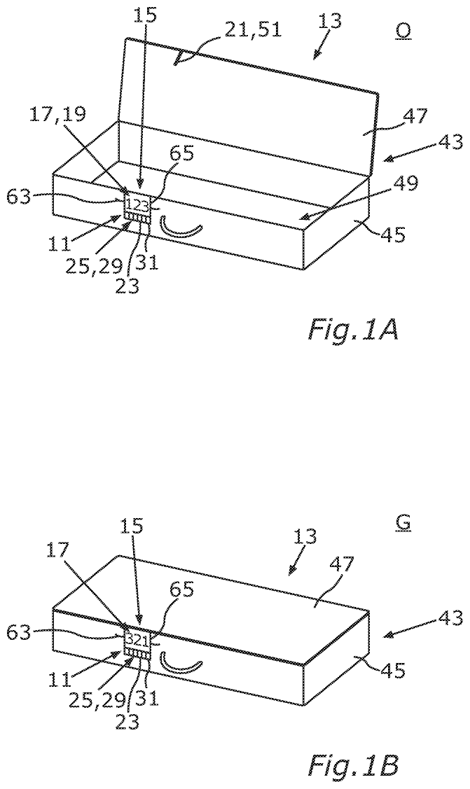

FIG. 1A shows a piece of luggage 13 that has a luggage body 43 having a first container part 45 and a second container part 47 movable relative to the first container part 45, wherein the second container part 47 enables access to an inner space 49 of the luggage body 43 in an open position O shown in FIG. 1A. A securing section 21 configured as a bolt is arranged at the second container part 47 and forms a luggage closure 51 of the piece of luggage 13.

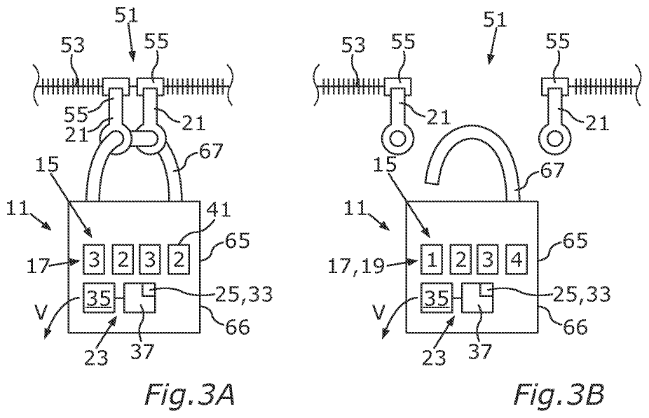

A luggage lock 11 is fastened to the second container part 45 by a fastening device 63, said luggage lock 11 having a combination locking mechanism 15 at which a numerical code 17, which by way of example comprises a numerical sequence of three numbers, may be set. The luggage lock 11 is provided to selectively lock or release the securing section 21 of the piece of luggage 13 relative to the luggage lock 11, wherein the released securing section 21, as FIG. 1A shows, is movable relative to the luggage lock 11 so that the second container part 47 may be moved into the open position O. The securing section 21 may in particular be released by setting a release code 19 at the combination locking mechanism 15, wherein code rings 41 may in particular be provided for setting the release code 19, which code rings 41 may have parallel offset axes of rotation or may be arranged coaxially to one another (cf. also FIGS. 3A and 3B).

On the other hand, after the transfer of the second container part 47 into a closed position G in which access to the inner space 48 of the luggage body 43 is blocked, the securing section 21 may be locked relative to the luggage lock 11 by setting a numerical code 17, which does not correspond to the release code 19, by the combination locking mechanism (cf. FIG. 1B). For this purpose, the securing section 21 may be introduced into a lock body 65 of the luggage lock 11 and may, for example, be held there by a latch, wherein a movement of the latch may be blocked by adjusting the release code 19 and the securing section 21 may thereby be locked relative to the luggage lock 11. Furthermore, the release code 19 may be changeable by the owner of the luggage lock 11. The operation of a combination locking mechanism is generally known to the skilled person and is, for example, known from U.S. Pat. No. 8,596,103 B2, EP 1 256 673 A1 and DE 10 2020 114 042 A1 so that it will not be looked at in more detail in the following.

The luggage lock 11 may in particular serve to secure the piece of luggage 13 against unauthorized access and in particular against theft of items carried in the piece of luggage 13, wherein it may furthermore be ensured by locking the piece of luggage 13 that, for example after the piece of luggage 13 has been handed in at a check-in counter, items, for example contraband items or drugs, are not subsequently introduced into the piece of luggage 13 by an unauthorized person.

However, the luggage lock 11 is configured to be opened non-destructively by a security institution if an employee of such a security institution wishes to check, for example in the course of a check at an airport, whether prohibited substances and/or items are taken along in the piece of luggage 13. To enable such a non-destructive check, the luggage lock 11 has an identification device 23 that provides a lock identification code 25 that is individually associated with the luggage lock 11. In the embodiment illustrated by FIGS. 1A and 1B, this lock identification code 25 is configured by way of example as a contactlessly optically readable optical code 29, in particular as a one-dimensional optical code or bar code. However, as an alternative to such a one-dimensional optical code 29, a two-dimensional optical code, in particular a QR code, may also be provided as a lock identification code 25, for example.

Such an optical code 29 may in particular be formed by laser engraving at the luggage lock 11. Furthermore, in the embodiment illustrated by FIGS. 1A and 1B, the code 29 is covered by a protective window 31 and is thereby protected against changes and/or damage to be able to ensure a reliable identification of the luggage lock 11 over a long time period.

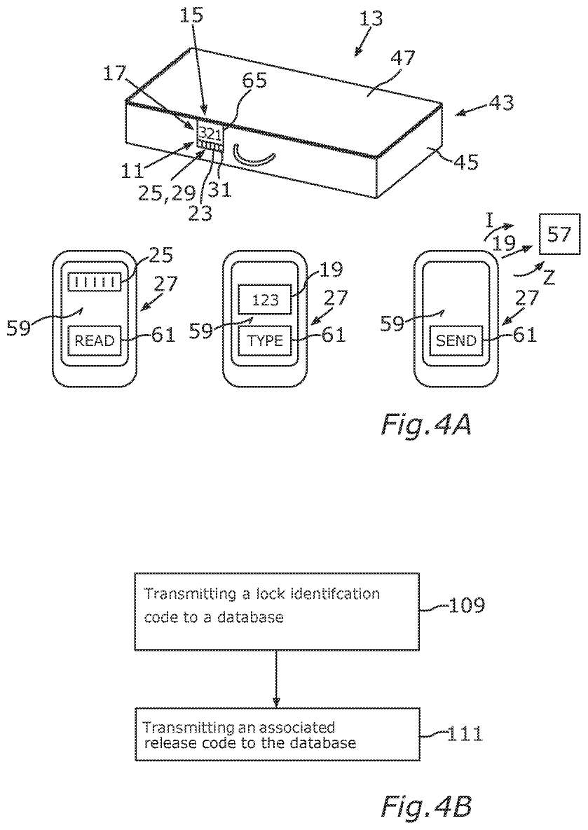

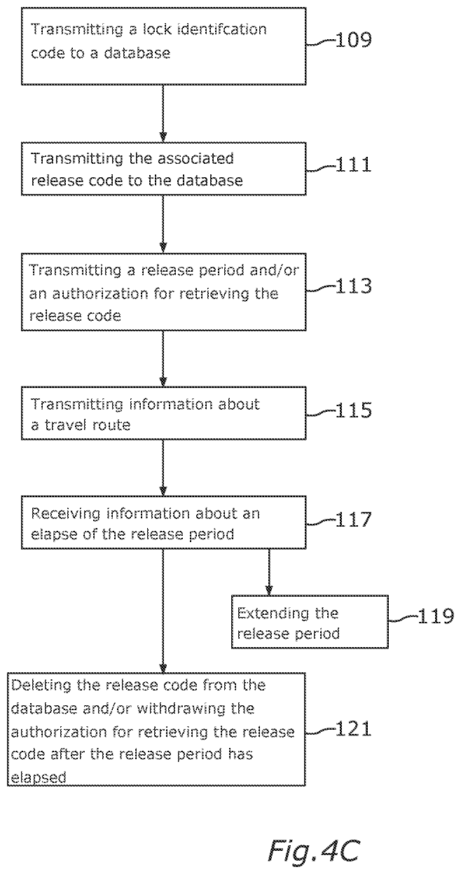

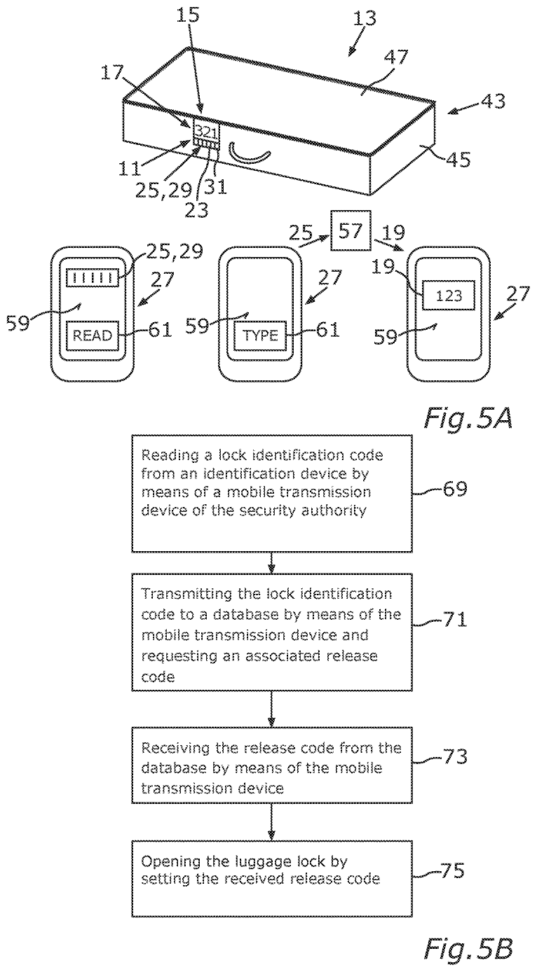

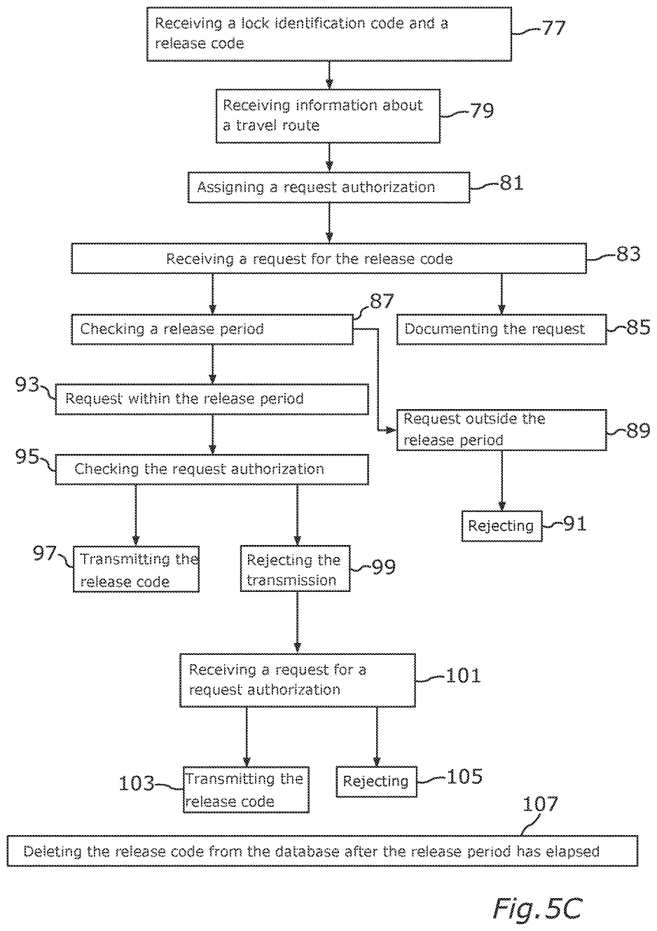

Since the luggage lock 11 has the identification device 23 having the lock identification code 25, the lock 11 may, for example, be uniquely identified in the course of a check by an employee of a security institution. This again enables an owner of the luggage lock 11 to transmit the lock identification code 25 and the associated release code 19 to a database 57 readable by the security institution before the start of a journey so that an employee of the security institution may read the lock identification code 25 and request the associated release code 19 from the database 57 (cf. also FIGS. 4A and 5A). After receiving the release code 19 from the database 57, the employee may thus open the luggage lock 11 non-destructively by setting the release code 19 and may perform a check of the piece of luggage 13 without a separate locking mechanism that bypasses the combination locking mechanism 15 having to be provided for the security institution. This is explained in more detail below.

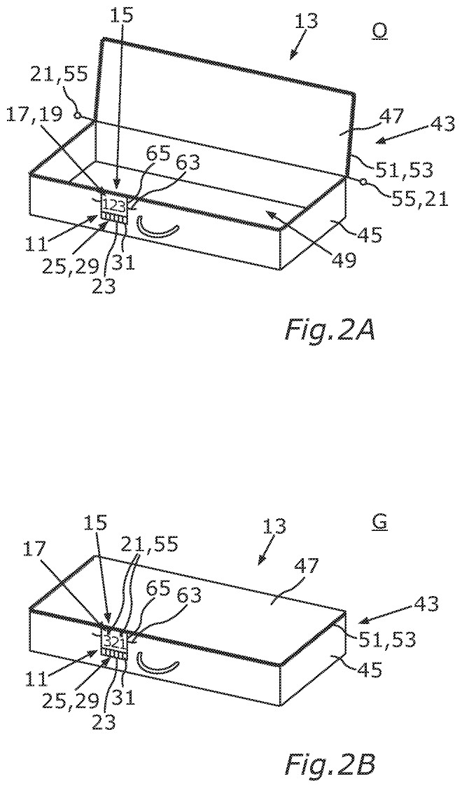

FIGS. 2A and 2B illustrate a further embodiment of a piece of luggage 13 in which a zipper 53 is provided as a luggage closure 51, via which zipper 53 the first container part 45 and the second container part 47 are connected to one another. As FIG. 2B illustrates, the zipper 53 may be closed by two movable handles 55 to keep the second container part 47 in the closed position G. Furthermore, the handles 55 form securing sections 21 of the piece of luggage 13 and may be introduced into a lock body 65 of the luggage lock 11 and locked relative to the luggage lock 11 by the combination locking mechanism 15 to secure the piece of luggage 13 against an unauthorized opening. The luggage lock 11 again has an identification device 23 that provides a lock identification code 25 in the form of an optically readable optical code 29 to enable an identification of the luggage lock 11 by an employee of a security institution.

While the luggage locks 11 of the pieces of luggage 13 that are shown in FIGS. 1A to 2B are integrated into the piece of luggage 13 or fastened to the first container part 45 by the respective fastening device 63 and may in particular not be released from the piece of luggage 13 by releasing the securing section 21, FIGS. 3A and 3B illustrate a luggage lock 11 that may be released from the piece of luggage 13 and may be opened non-destructively by a security institution. The luggage lock 11 comprises a lock body 65 and a U-shaped hoop 67 that may be introduced into the lock body 65 and locked there by the combination locking mechanism 15 by setting a numerical code 17 that does not correspond to the release code 19. As FIG. 3A illustrates, the luggage lock 11 may, for example, be used to connect two handles 55 of a zipper 53, which may form securing sections 21 of a piece of luggage 13, to one another and to lock them relative to the luggage lock 11 by locking the hoop 67. By unlocking the hoop 67, the hoop 67 may be released from the handles 55 of the zipper 53 so that the securing sections 21 or the handles 55 are released relative to the luggage lock 11 and the zipper 53 may be opened to be able to access the inner space 48 of the piece of luggage 13.

Furthermore, in the embodiment of the luggage lock 11 illustrated by FIGS. 3A and 3B, an identification device 23 is again provided that provides a lock identification code 25, wherein the latter may be read via a radio connection V. For this purpose, the identification device 23 comprises an active or passive transponder 35 that may, for example, be configured to transmit an electronically detectable code 33 stored in a memory 37 as a lock identification code 25 to a mobile transmission device 27 via the radio connection V, for example an RFID connection, in particular an NFC connection, or a Bluetooth connection (cf. also FIGS. 4A and 5A). The memory 37 may furthermore be provided to document a reading of the lock identification code 25 so that an owner of the luggage lock 11 may, for example, track whether a check of the piece of luggage 13 has been performed or at least the prerequisite has been provided by querying the lock identification code 25. Furthermore, provision may, for example, be made to store, in the memory 37, a device identification with respect to the reading transmission device 27, a point in time of the request, and/or information about a location of the request. Furthermore, the transponder 35 may in particular be embedded in a housing 66, in particular an outer plastic housing, of the luggage lock 11.

FIGS. 4A to 4C illustrate methods of providing the release code 19 for opening the luggage locks 11 illustrated by FIGS. 1A to 3B for a security institution. First, in a step 109, the lock identification code 25 may be transmitted to a database 57 that may be read by the security institution. Furthermore, the associated release code 19 may be transmitted to the database 57 in a step 111 so that a data pair of the lock identification code 25 and the associated release code 19 may ultimately be stored in the database 57.

As FIG. 4A shows, prior to transmitting the lock identification code 25, provision may, for example, be made that an owner of the luggage lock 11 reads the lock identification code 25 by a mobile transmission device 27, in particular a smartphone and/or its camera. For this purpose, the owner may, for example, direct the transmission device 27 to the optical code 29 and read the lock identification code 25 by pressing a button 61 at an input device 59 of the transmission device 27, in particular a touch screen. In a subsequent step, the owner may enter the release code 19 associated with the luggage lock 11 and, to that extent, its lock identification code 25 as a numerical sequence via the input device 59 and may then transmit the data pair of the lock identification code 25 and the release code 19 to the database 57 by pressing a button 61. This provision of the data pair at the database 57 then enables an employee of the security institution to request the associated release code 19 from the database 57 by reading the lock identification code 25 and to open the luggage lock 11 non-destructively by setting the received release code 57 at the combination locking mechanism 15.

As FIG. 4C further illustrates, in addition to transmitting the lock identification code 25 and the release code 19, provision may be made in a step 113 that the owner of the luggage lock 11 transmits a release period Z to the database 57 and/or an authorization for retrieving the release code 19. In particular, the owner of the luggage lock 11 may thereby specify that the release code 19 may only be read from the database 57 and/or stored in the database 57 for a specific release period Z, wherein only the owner may open the luggage lock 11 after the release period Z has elapsed. This may also be achieved by the owner first transmitting an authorization for retrieving the release code 19 to the database 57, but withdrawing this authorization after a journey is completed, for example. Furthermore, the owner may, for example, change the release code 19 after receiving the piece of luggage 13 to ensure that persons who gain access to the database 57 in an unauthorized manner may also not open the luggage lock 11.

In a step 115, information I about a travel route may furthermore be transmitted to the database 57, which information I may, for example, comprise an origin airport, a destination airport, an airline, a flight number, and/or information about various stopovers. It may thereby be communicated to the security institution via which travel route the piece of luggage 13 will be conducted so that the security institution may, for example, only enable access to the release code 19 for a selection of employees who are stationed along the travel route.

Furthermore, information about an elapse of the release period Z may be received at the transmission device 27 of the owner in a step 117 so that the owner may selectively extend the release period Z in a step 119. In particular, the owner may therefore also enable the security institutions to access the piece of luggage 13 in the event of a possible delay of a journey until the completion of the journey by extending the release period Z accordingly.

In a step 121, provision may be made that the owner, by an appropriate command by the transmission device 27, deletes the release code 19 from the database 57 after the release period Z has elapsed and/or after a journey has been completed so that the release code 19 is no longer available in the database 57. Alternatively or additionally, the authorization for retrieving the release code 19 may also be withdrawn. Furthermore, the owner of the luggage lock 11 may, for example, also change the release code 19 after a journey has been completed to ensure that persons who gain access to the database 57 in an authorized or unauthorized manner are also unable to open the luggage lock 11.

FIGS. 5A to 5C illustrate a method of opening a luggage lock 11 by a security institution. In a step 69, an employee of the security institution who wants to perform a check of the piece of luggage 13 may in particular read the lock identification code 25 from the identification device 23 of the luggage lock 11 by a mobile transmission device 27 of the security institution, in particular by a smartphone. This is again illustrated by FIG. 5A by way of example for the reading of an optical code 29, wherein, alternatively thereto, the reading of an electronic code 33 provided via a radio connection V may in particular also take place by such a transmission device 27 (cf. also FIGS. 3A and 3B). Thereupon, by actuating a button 61 at an input device 59 of the transmission device 27, the employee of the security institution may transmit the read lock identification code 25 to the database 57 and request the associated release code 19. The release code 19 may be transmitted from the database 57 to the transmission device 27 and may be received and displayed at the transmission device 27 (step 73), whereupon the employee of the security institution may open the luggage lock 11 non-destructively in a step 75 by setting the received release code 19.

FIG. 5C illustrates further steps that may in particular be performed by the security institution after receiving a data pair of a lock identification code 25 and an associated release code 19 in a step 77.

For example, in a step 79, information I about a travel route may be received, wherein this information I may in particular be provided by an owner of the luggage lock 11. Alternatively thereto, it is, however, also possible for employees of an airline to transmit information I about the travel route, for example after checking in a piece of luggage 13, to the database 57. Depending on the information I about the travel route, the security institution may, in a step 81, assign a request authorization to different employees, wherein a request authorization may, for example, be assigned to those employees who are stationed along the travel route or to their transmission devices 27. Alternatively thereto, it is generally also possible to assign a request authorization to all the employees of the security institution.

In a step 83, a request for the release code 19 may be received at the database 57. Such a request may in particular be transmitted by an employee of the security institution in the step 71 already mentioned when the employee would like to perform a check of the piece of luggage 13.

The request may be documented in the database 57 in a step 85, wherein in particular a point in time of the request, information about the requesting transmission device 27, in particular a device identification, and/or information about the location from which the request was sent may be documented. This may in particular enable the security institution to track whether and to what extent checks are performed, wherein information as to whether the piece of luggage 13 was opened may furthermore possibly also be provided to the owner.

Furthermore, as a result of receiving the request for the release code 19, it may be checked in a step 87 whether the request was received within a release period Z. If it is determined in a step 89 that the request was received outside the release period Z, the request may be rejected in a step 91 and the release code 19 may not be transmitted. Alternatively thereto, provision may also be made to send a request to extend the release period Z to the owner of the luggage lock 11 so that the owner may subsequently extend the release period Z, for example as a result of a delay in a journey, and may ensure that the luggage lock 11 may be opened non-destructively for the entire period of the journey.

If, on the other hand, it is determined in a step 93 that the request was transmitted within the release period Z, it may be checked in a step 95 whether the requesting transmission device 27 and/or the requesting person has a request authorization. For example, the check of the request authorization may take place by a legitimation check and/or identity check at the transmission device 27. If such a request authorization exists, the release code 19 may be transmitted to the requesting transmission device 27 in a step 97 and the opening of the luggage lock 11 may thus be made possible for the employee. If, on the other hand, no request authorization is present, the transmission may be rejected in a step 99, whereupon, however, a request for a request authorization may possibly be received in a step 101. This may enable an employee of the security institution who did not originally have a request authorization to nevertheless request a request authorization to be able to perform a check of the piece of luggage 13.

As a result of the request for the request authorization, such a request authorization may possibly be granted and the release code 19 may be transmitted in a step 103 so that a check of the piece of luggage 13 may take place. The request authorization may in particular be granted indirectly by transmitting the release code 19. Alternatively thereto, the request may, however, also be rejected in a step 105 so that the release code 19 is ultimately not transmitted.

Furthermore, provision may be made in a step 107 that the release code 19 is deleted from the database 57 after the release period Z has elapsed. Due to such an approach, it may be guaranteed for the owner of the luggage lock 11 that access to the release code 19 is only possible during a release period Z determined by the owner, whereas an opening of the luggage lock 11 by unauthorized persons after the release period Z has elapsed may not take place, even in the event of a manipulation of the database 57.

### REFERENCE NUMERAL LIST

11 luggage lock
13 piece of luggage
15 combination locking mechanism
17 numerical code
19 release code
21 securing section
23 identification device
25 lock identification code
27 mobile transmission device
29 optical code
31 protective window
33 electronic code
35 transponder
37 memory
41 code ring
43 luggage body
45 first container part
47 second container part
49 inner space
51 luggage closure
53 zipper
55 handle
57 database
59 input device
61 button
63 fastening device
65 lock body
66 housing
67 hoop
69 step
71 step
73 step
75 step
77 step
79 step
81 step
83 step
85 step
87 step
89 step
91 step
93 step
95 step
97 step
99 step
101 step
103 step
105 step
107 step
109 step
111 step
113 step
115 step
117 step
119 step
121 step
G closed position
I information
O open position
V radio connection
Z release period

1. A luggage lock for securing a piece of luggage that can be opened without destruction by a security institution, the luggage lock comprising a combination locking mechanism at which a numerical code can be manually set,
wherein a securing section of the piece of luggage can, by the combination locking mechanism, be selectively locked relative to the luggage lock to secure a closed state of the piece of luggage or be released to allow an opening of the piece of luggage,
wherein the securing section of the piece of luggage can be released by setting a numerical code at the combination locking mechanism that corresponds to a release code, and wherein the securing section of the piece of luggage can be locked by setting a numerical code at the combination locking mechanism that does not correspond to the release code,
wherein the release code can be changed by an owner of the piece of luggage, and
wherein the luggage lock further has an identification device that provides a lock identification code that is individually associated with the luggage lock and that can be read in a contactless manner.

2. The luggage lock in accordance with claim 1,
wherein the lock identification code is at least one of machine-readable by of a mobile transmission device or readable via a radio connection,

3. The luggage lock in accordance with claim 1,
wherein the lock identification code comprises an optically readable one-dimensional or two-dimensional optical code, and
wherein the optically readable code is covered by a protective window.

4. (canceled)

5. The luggage lock in accordance with claim 1, wherein the lock identification code is formed by laser engraving at the luggage lock.

6. (canceled)

7. The luggage lock in accordance with claim 1, wherein the identification device comprises an active or passive transponder for storing and transmitting the lock identification code.

8. The luggage lock in accordance with claim 7, wherein the transponder is embedded in a housing of the luggage lock.

9. A piece of luggage, comprising a luggage body having a securing section, a first container part and a second container part movable relative to the first container part between an open position and a closed position, further comprising a luggage lock in accordance with claim 1,
wherein the second container part enables access to an inner space of the luggage body in the open position and blocks access in the closed position, and
wherein the second container part can be secured in the closed position by locking the securing section.

10. (canceled)

11. A method of providing a release code for a security institution for opening a luggage lock that has a combination locking mechanism at which a numerical code can be manually set, comprising the steps
transmitting a lock identification code that is individually associated with the luggage lock to a database, and
transmitting a release code that is associated with the combination locking mechanism to the database.

12. The method in accordance with claim 11, wherein the database is readable by the security institution.

13. The method in accordance with claim 11, wherein the lock identification code and the release code are transmitted to the database by a mobile transmission device via a wireless connection.

14. The method in accordance with claim 11, wherein the lock identification code is at least one of:
contactlessly machine-read by the transmission device from an identification device of the luggage lock;
read by the transmission device from a memory of the transmission device before the transmission to the database; or
selected at the transmission device.

15. (canceled)

16. The method in accordance with claim 11, wherein the release code is entered at an input device of the transmission device and then transmitted to the database.

17. (canceled)

18. The method in accordance with claim 11, wherein information about a release period for which the release code is accessible in the database is transmitted to the database.

19. The method in accordance with claim 11, wherein an authorization for a retrieval of the release code from the database is at least one of granted to the database or withdrawn from the database.

20. The method in accordance with claim 11, wherein information about a travel route, is transmitted to the database.

21. A method of opening a luggage lock, which has a combination locking mechanism and a contactlessly readable identification device, by a security institution,
comprising the steps:
reading a lock identification code of the luggage lock from the identification device,
transmitting the lock identification code by a mobile transmission device of the security institution to a database and requesting an associated release code for unlocking the combination locking mechanism,
receiving the release code from the database by the mobile transmission device, and
opening the luggage lock by setting the received release code at the combination locking mechanism.

22. (canceled)

23. (canceled)

24. (canceled)

25. The method in accordance with claim 21, wherein at least one of the request for the release code, a point in time of the request for the release code, a location of the request for the release code, a device identification of the mobile transmission device of the security institution or a person identification of a requesting user is documented in the database.

26. The method in accordance with claim 21, wherein a request authorization is assigned to at least one of a plurality of mobile transmission devices or a plurality of persons, and wherein the release code is only transmitted when the release code is requested by at least one of an authorized person or an authorized transmission device.

27. (canceled)

28. The method in accordance with claim 26, wherein the request authorization is at least one of:
assigned in dependence on information about a travel route, the information being stored in the database and being associated with the lock identification code of the luggage lock; or
requestable by the transmission device.

29. (canceled)

30. The method in accordance with claim 21, wherein the release code is deleted from the database after a release period stored in the database has elapsed.
